(19) United States
(12) Patent Application Publication
(10) Pub. No.: US 2014/0181166 A1
(43) Pub. Date: Jun. 26, 2014

(54) APPARATUS FOR LOW COMPLEXITY SUB-NYQUIST SAMPLING OF SPARSE WIDEBAND SIGNALS

(71) Applicant: INDUSTRIAL TECHNOLOGY RESEARCH INSTITUTE, Hsinchu (TW)

(72) Inventors: Chun-Hsiung CHUANG, Hsinchu City (TW); Chia-Hua LIN, Hsinchu County (TW); Shang-Ho TSAI, Hsinchu City (TW); Kai-Jiun YANG, Zhubei City (TW)

(73) Assignee: INDUSTRIAL TECHNOLOGY RESEARCH INSTITUTE, Hsinchu (TW)

(21) Appl. No.: 13/727,461

(22) Filed: Dec. 26, 2012

(51) Int. Cl. G06F 7/58; G06F 17/10

(52) U.S. Cl. CPC G06F 7/582; G06F 17/10
USPC 708/250

(57) ABSTRACT

An apparatus for low complexity sub-Nyquist sampling of sparse wideband signals is provided, including a mixer, a periodic random sequence generator and a filter bank. The periodic random sequence generator generates a periodic pseudo-random sequence. The mixer is connected to the periodic random sequence generator for receiving the periodic pseudo-random sequence and mixing with an input signal to obtain a modulated signal. The filter bank further includes a plurality of filters and is connected to the mixer for filtering the modulated signal. The sub-Nyquist sampling apparatus may further includes a plurality of analog-to-digital convertors (ADCs), with each ADC connected to each filter of the filter bank to sample the signal from the filter bank and output a sampling signal.

### TECHNICAL FIELD

The present disclosure generally relates to an apparatus for low complexity sub-Nyquist sampling of sparse wideband signals.

### BACKGROUND

Compressed sensing (CS), a method able to capture and represent compressible signals at a rate significantly below the Nyquist rate, employs non-adaptive linear projections that preserve the structure of the signal. The signal is then reconstructed from these projections using an optimization process. CS is proposed for the acquisition of sparse signals using a sampling rate significantly lower than Nyquist rate. The reconstructed signals in compressed sensing can be treated as a solution of the 1-norm optimization problem. Moreover, CS has been particularly influential in contributing insights into the design of wideband receivers, and some of the promising notable applications are: light detection and ranging (LiDAR), frequency hopping, cognitive radio, impulse radio, spectrum sensing in communication systems, sensor network and imaging processing.

Some works have been proposed to explore the use of CS in designs. For example, a method called random demodulator (RD) is proposed as a wideband receiver for reducing the sampling rate below Nyquist rate by utilizing high rate pseudo-random mixer to generate measurement matrix, which resulting in high computational complexity of signal reconstructions for DSP processors. A modulated wideband converter (MWC) is also proposed to realize the hardware design of a sub-Nyquist sampling and signal restoration architecture. MWC mitigates the need of a high bandwidth and hence reduces the complexity of designs. The architecture employs a plurality of mixers and branches of analog-to-digital convertors (ADCs) with pseudo-random periodic sequences and low-pass filters. A compressive sensor array (CSA) system and method disclose a compressive sampling technique to acquire sensor data from an array of sensors without independently sampling each of the sensor signals. The approaches include modulating the analog sensor signals based on a random modulation sequence to establish a sparse measurement basis and combining the modulated analog sensor signals to produce a composite analog sensor signals.

### SUMMARY

The present disclosure has been made to overcome the above-mentioned conventional drawback for sub-Nyquist sampling of sparse wideband signals.

An exemplary embodiment of the present disclosure provides an apparatus for low complexity sub-Nyquist sampling of sparse wideband signals, which includes a mixer, a periodic random sequence generator and a filter bank, wherein the periodic random sequence generator generates a periodic pseudo-random sequence; the mixer is connected to the periodic random sequence generator for receiving the periodic pseudo-random sequence and mixing with an input signal to obtain a modulated signal; and the filter bank further includes a plurality of filters and is connected to the mixer for filtering the modulated signal. The sub-Nyquist sampling apparatus may further includes a plurality of analog-to-digital convertors (ADCs), with each ADC connected to each filter of the filter bank to sample the signal from the filter bank and output a sampling signal.

The preceding summary and the following detailed description are exemplary only and do not limit of the scope of the claims.

### BRIEF DESCRIPTION OF THE DRAWINGS

The present disclosure can be understood in more detail by reading the subsequent detail description in conjunction with the examples and references made to the accompanying drawings, wherein:

FIG. 1 shows a schematic view of an apparatus for low complexity sub-Nyquist sampling of sparse wideband signals according to an exemplary embodiment;

FIGS. 2A-2C shows a schematic view of the frequency spectrums of compressed sensing of a multiband signal according to an exemplary embodiment;

FIGS. 3A-3F shows a waveform view of a simulation of reconstructing multiband signal according to an exemplary embodiment; and

FIG. 4 shows a simulation result of the performance comparison between the present disclosure and the conventional MWC scheme.

### DETAILED DESCRIPTION OF DISCLOSED EMBODIMENTS

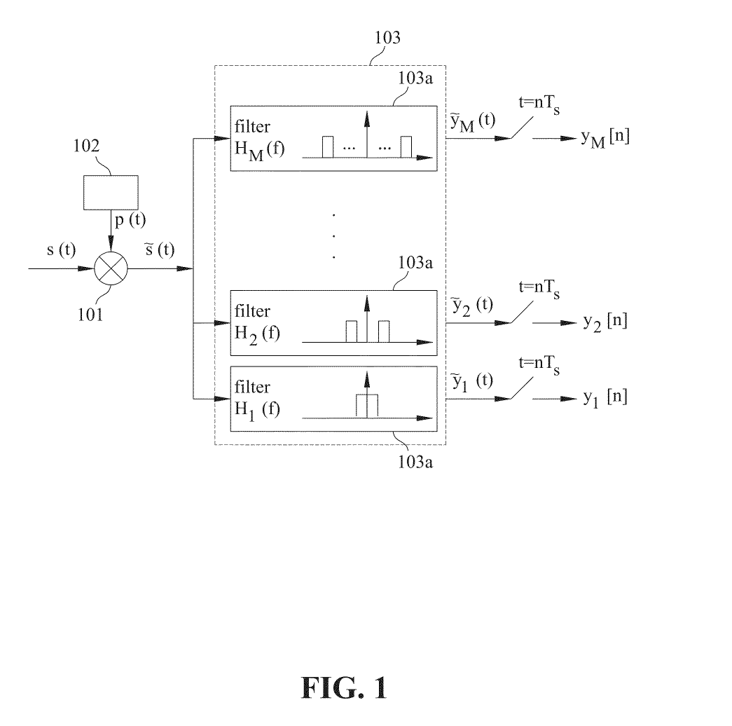

FIG. 1 shows a schematic view of an apparatus for low complexity sub-Nyquist sampling of sparse wideband signals according to an exemplary embodiment. As shown in FIG. 1, a sub-Nyquist sampling apparatus includes a mixer 101, a periodic random sequence generator 102 and a filter bank 103, wherein periodic random sequence generator 102 generates a periodic pseudo-random sequence p(t), where t stands for variable of time; mixer 101 is connected to periodic random sequence generator 102 for receiving the periodic pseudo-random sequence p(t) and mixing with input signal s(t) at time t to obtain modulated signal \tilde{s}(t); and filter bank 103 further includes a plurality of filters 103a and is connected to mixer 101 for filtering modulated signal \tilde{s}(t) into signal \tilde{y}m(t) . Sub-Nyquist sampling apparatus further includes a plurality of analog-to-digital convertors (ADCs), with each ADC is connected to each filter 103a of filter bank 103 to sample the signal \tilde{y}ₘ (t) and output sampling signal yₘ[n], where m ranges from 1 to M, M is the number of filters, and n is an index of domain samples.

It is worth noting that the periodic pseudo-random sequence p(t) can be chosen as a piecewise continuous-time function that takes values ±1 with equal probability for each of P equals to time intervals, i.e.,

$$p ( t ) = {β}_{k} , k \frac{{T}_{p}}{P} \leq t \leq ( k + 1 ) \frac{{T}_{p}}{P} , \\ 0 \leq k \leq P - 1 \qquad ( 1 )$$

where βₖ ∈{+1,−1}, p(t)=p(t+nTₚ) for every n∈Z and 1/Tₚ=fp, Tₚ is the period of the periodic pseudo random sequence, and P is the number of time intervals within Tₚ.

In other words, periodic random sequence generator 102 can be configured to generate the sequence of (1).

In addition, mixer 101 mixes, i.e., modulated, input signals s(t) with p(t) to obtained modulated signal \tilde{s}(t). As the p(t) is periodic, mixer 101 is rotation-based. Since the mixing function p(t) is Tₚ-periodic, the corresponding Fourier expansion is given by

$$\begin{matrix}p ( t ) = {\sum }_{i = - ∞}^{∞} {c}_{i} {e}^{j \frac{2 π}{{T}_{p}} it} \\ where & ( 2 ) \\ {c}_{i} = \frac{1}{{T}_{p}} {\int }_{0}^{{T}_{p}} p ( t ) {e}^{- j \frac{2 π}{{T}_{p}} it} d t & ( 3 )\end{matrix}$$

The Fourier transform of the modulated signal \tilde{s}(t)=s(t)p(t) can be expressed as:

$$\tilde{S} ( f ) = {\sum }_{i = - ∞}^{∞} {c}_{i} S ( f - {if}_{p} ) \qquad ( 4 )$$

wherein \tilde{s}(f) is the frequency domain signal, as opposite to time domain signal \tilde{s}(t).

As aforementioned, filter bank 103 includes a plurality of filters 103a. The number of filters in filter bank 103 can vary. In this embodiment, the number of filters 103a in filter bank 103 is denoted as M, with each filter m defined with a band-pass filtering function Hₘ(f), which can be realized by any two-sided signals, such as, Quadrature Mirror Filter (QMF). It should be noted that filter bank 103 can be used to acquire frequency information modulated on different bands. In addition, since a single mixer is used, filter bank 103 is aware of the start point from the periodic random sequence generator 102 because all inputs are aligned, which makes synchronization easy. As the modulated signal contains the real part, the corresponding frequency response is conjugate-symmetric. For convenience of description, the band of filter 103a is described in the positive frequency band, wherein the first filter H₁(f) is an ideal low-pass filter and the other filters are ideal band-pass filters Hₘ(f), defined as:

$${H}_{m} ( f ) = \{ \begin{matrix}1 & \frac{( m - 1 )}{2} {f}_{s} \leq f \leq \frac{m}{2} {f}_{s} \\ 0 & otherwise ,\end{matrix} \\ 1 \leq m \leq M \qquad ( 5 )$$

where 1/Tₛ=fₛ is the sampling frequency of the ADC connected to the filter respectively. For the present embodiment, the sampling rate of the ADC satisfies fₛ=qfₚ with q∈N, where q is the sampling factor.

Originally in (4), the modulated signal \tilde{s}(t) is an infinite linear combination of fₚ-shifted copies of S(f). After passing through the filter Hₘ(f), however, the filtered signal becomes a finite linear combination. Thus, yₘ [n] can be expressed as

$${Y}_{m} ( f ) = {\sum }_{i = - I}^{I} {c}_{i} S ( f - {if}_{p} ) , \\ f ∈ [ \frac{( m - 1 )}{2} {f}_{s} , \frac{m}{2} {f}_{s} ] \qquad ( 6 )$$

where a value I is calculated by

$$I = ⌈ \frac{W + {f}_{s}}{2 {f}_{p}} ⌉ - 1 \qquad ( 7 )$$

where W is the bandwidth.

The relation of signal processing between signals \tilde{y}ₘ(t) and yₘ[n] can be described as follows.

For \tilde{y}₁(t), which is a baseband signal filtered by the low-pass filter H₁(f), the output yₘ[n] is exactly the sampled signal from the respective ADC. For \tilde{y}ₘ(t), m≠1, which are band-pass signals and have modulated frequency higher than the sampling rate of the ADCs, the band-pass theory may be applied to let fₛ=qfₚ, q∈N, to avoid aliasing. In this case, each resulting signal \tilde{y}ₘ(t), m≠1, is not aliasing and may be regarded as an interpolated signal having a plurality of copies in frequency domain. By passing \tilde{y}ₘ[n], m≠1, through an ideal digital filter with a pass-band of [0 fₛ/2], or a proper down-sampling process, the resulting signal zₘ[n], m≠1, is a baseband signal with information contained in [0,+fₛ/2]. Let the discrete-time Fourier transform (DTFT) of zₘ[n] be Zₘ(f), which can be expressed as:

$${Z}_{m} ( f ) = {\sum }_{i = - I}^{I} {c}_{i} S ( f - {if}_{p} + {mf}_{s} ) , \\ f ∈ [ {0}_{s} , + \frac{{f}_{s}}{2} ] \qquad ( 8 )$$

Assume that the bandwidth of the multiband signal is within the Nyquist frequency. Also, for convenience of analysis, let fₛ=fₚ so that (8) becomes:

$${Z}_{m} ( f ) = {\sum }_{i = - I}^{I} {c}_{i} S ( f - ( i - m ) {f}_{s} ) , \\ f ∈ [ {0}_{s} , + \frac{{f}_{s}}{2} ] \qquad ( 9 )$$

The equation in (9) can be represented by a matrix form, i.e.

Zₘ(f)=φ₁xₘ(f) (10)

where

φ₁=[c_{-I}. . . c₀ . . . c_{I}] (11)

and

xₘ(f)=[S(f+(I−m+1)fₚ) . . . S(f−Ifₚ)0^{T}]^{T} (12)

is a (2I+1)×1 column vector with last m−1 elements being zeros.

It is equivalent to rewriting (10) as

Zₘ(f)=φ₁xₘ(f)=φₘx₁(f) (13)

where

φₘ=[0^{T}c_{-I} . . . c_{I-m}] (14)

with first m−1 elements being zeros.

The M φₘ vectors are collected from the M branches and a matrix Φ is defined as:

Φ=[φ₁^{T}φ₂^{T} . . . φ_{M}^{T}]^{T}

Then, (13) can be rewritten in a matrix form as:

z(f)=Φx₁(f) (15)

where

z(f)=[Z₁(f) . . . Z_{M}(f)]^{T} (16)

A compressed sensing (CS) matrix is denoted by Φ, Φ∈C^{M×(2I+1)}. For the presented disclosure, the CS matrix is a Toeplitz matrix, in which each descending diagonal from left to right is constant. For instance, let I=3 and M=3, then the matrix Φ can be expressed as:

$$Φ = [ \begin{matrix}{c}_{- 1} & {c}_{0} & {c}_{1} & {c}_{2} & {c}_{3} & 0 & 0 \\ {c}_{- 2} & {c}_{- 1} & {c}_{0} & {c}_{1} & {c}_{2} & {c}_{3} & 0 \\ {c}_{- 3} & {c}_{- 2} & {c}_{- 1} & {c}_{0} & {c}_{1} & {c}_{2} & {c}_{3} \\ 0 & {c}_{- 3} & {c}_{- 2} & {c}_{- 1} & {c}_{0} & {c}_{1} & {c}_{2} \\ 0 & 0 & {c}_{- 3} & {c}_{- 2} & {c}_{- 1} & {c}_{0} & {c}_{1}\end{matrix} ] \qquad ( 17 )$$

The coefficients cᵢ in matrix Φ can be obtained by performing the Fourier transform on the βₖ, that is:

$${c}_{i} = \frac{1}{P} {\sum }_{k = 0}^{P - 1} {β}_{k} {e}^{- j \frac{2 π}{P} ik} , \\ - I \leq i \leq I \qquad ( 18 )$$

Because of the Toeplitz structure of matrix Φ, the storage requirement is only 1/(2M) of storage required in the conventional MWC scheme.

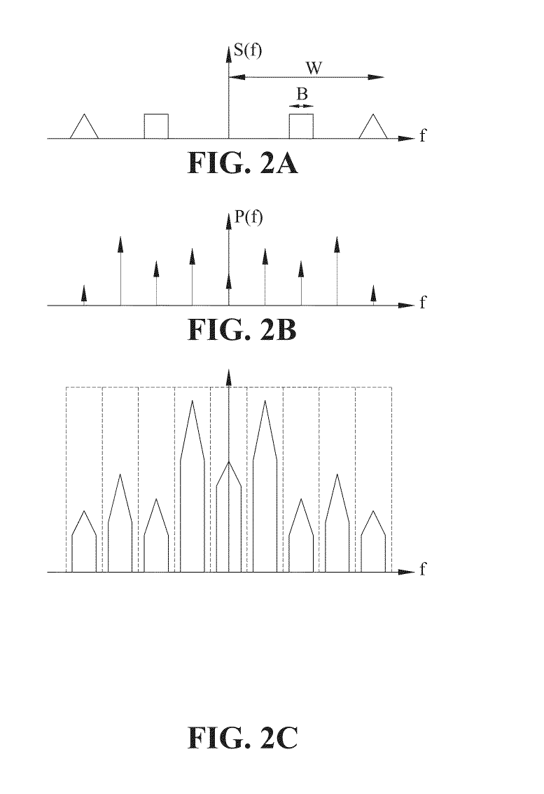

FIGS. 2A-2C show a schematic view of the frequency spectrums of compressed sensing of a multiband signal according to an exemplary embodiment. FIG. 2A shows a frequency spectrum of a multiband signal S(f), wherein W is the Nyquist frequency and B is bandwidth of a signal band; FIG. 2B shows a frequency spectrum of a periodic pseudo-random sequence P(f); and FIG. 2C shows a frequency spectrum after the filter bank.

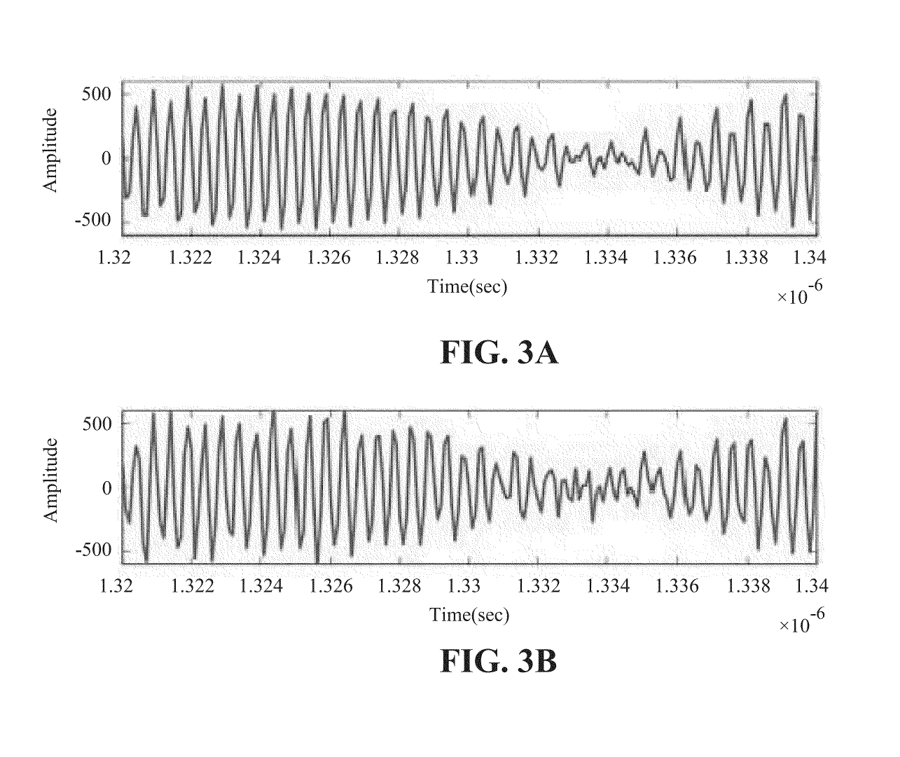

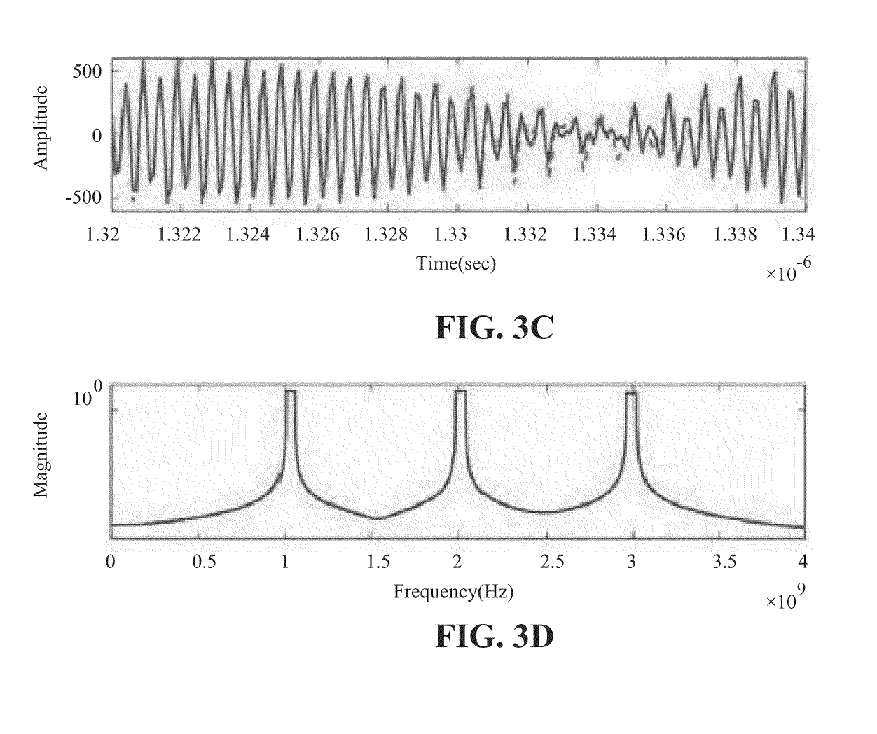

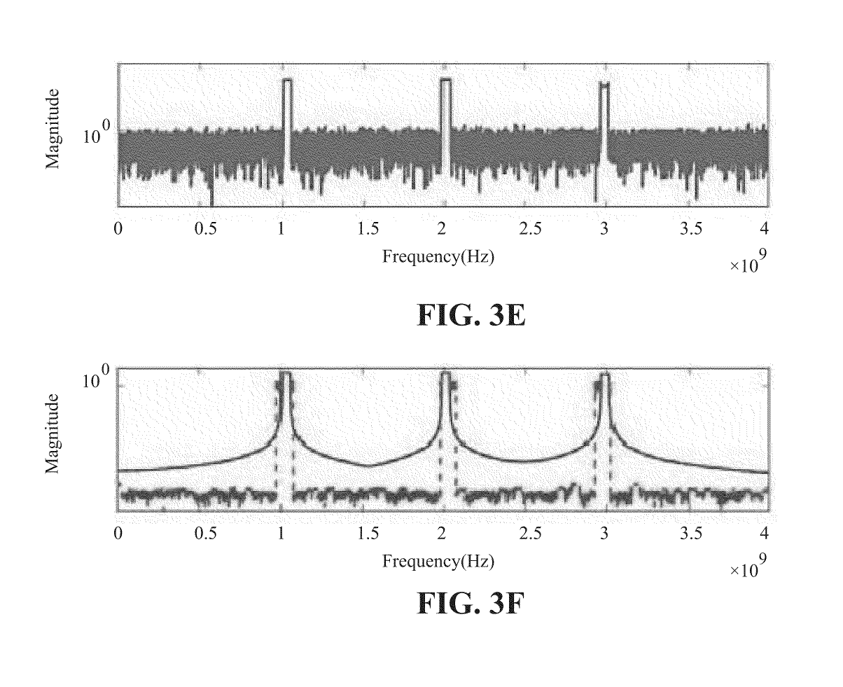

FIGS. 3A-3F shows a waveform view of a simulation of reconstructing multiband signal according to an exemplary embodiment. The parameters of the simulation are set as follows: N=6, B=50 MHz, W=10 GHz, length of random sequence (P)=200, M=25, fₛ=fₚ=50 MHz, and signal-to-noise ratio (SNR)=20 dB. FIG. 3A shows a time domain waveform of the original signal, FIG. 3B shows a time domain waveform of the noisy signal, FIG. 3C shows a time domain waveform of the original and reconstructed signal (depicted as dotted line), FIG. 3D shows a spectrum of the original signal, FIG. 3E shows a spectrum of the noisy signal, and FIG. 3F shows a spectrum of the original and reconstructed signal (depicted as dotted line).

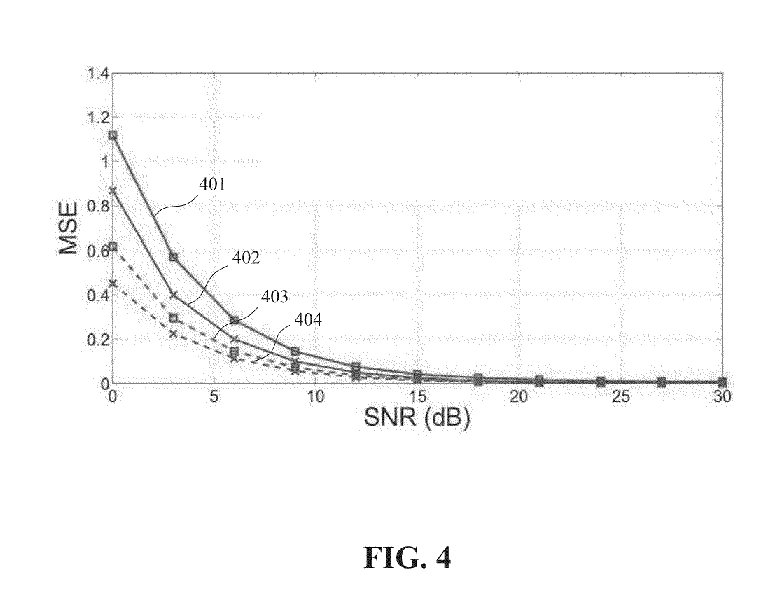

FIG. 4 shows a schematic view of simulation result of the performance comparison between the present disclosure and the conventional MWC scheme. The performance is plotted as mean square error (MSE) vs. SNR. As shown in FIG. 4, line 401 is the MSE of using MWC scheme with M=25 branches, compared to line 402, which is the MSE of the present disclosure with M=25 branches. Similarly, line 403 is the MSE of using MWC scheme with M=35 branches, compared to line 404, which is the MSE of the present disclosure with M=35 branches. When SNR is less than 5 dB, the present disclosure can achieve 1 dB performance gain.

In terms of storage requirement, the simulation result shows that for a case of W=10 GHz and M=35, the present disclosure only requires a memory size of 100×1, compared to the conventional MWC scheme requiring a memory size of 100×35.

Although the present disclosure has been described with reference to the preferred embodiments, it will be understood that the disclosure is not limited to the details described thereof. Various substitutions and modifications have been suggested in the foregoing description, and others will occur to those of ordinary skill in the art. Therefore, all such substitutions and modifications are intended to be embraced within the scope of the disclosure as defined in the appended claims.

What are claimed are:

1. An apparatus for low complexity sub-Nyquist sampling of sparse wideband signals, comprising:
a mixer;
a periodic random sequence generator; and
a filter bank, further comprising a plurality of filters;
wherein said periodic random sequence generator generating a periodic pseudo-random sequence; said mixer being connected to said periodic random sequence generator for receiving said periodic pseudo-random sequence and mixing with an input signal to obtain a modulated signal; and said filter bank being connected to said mixer for filtering said modulated signal.

2. The apparatus as claimed in claim 1, further comprising a plurality of analog-to-digital convertors (ADCs), with each ADC connected to each said filter of said filter bank to sample the signal from said filter bank and outputting a sampling signal.

3. The apparatus as claimed in claim 1, wherein said filter of said filter bank is a Quadrature Mirror Filter (QMF) or a band-pass filter.

4. The apparatus as claimed in claim 1, wherein said filter bank comprises a low-filter and a plurality of band-pass filters.

5. The apparatus as claimed in claim 1, wherein said periodic pseudo-random sequence is a piecewise continuous-time function having values ±1 with equal probability for each of a plurality of equal time intervals.

6. The apparatus as claimed in claim 1, wherein a compressed sensing matrix resulted from said apparatus is a Toeplitz matrix.
